(19) United States
(12) Patent Application Publication
(10) Pub. No.: US 2011/0206493 A1
(43) Pub. Date: Aug. 25, 2011

(54) Catalyst Foils and Methods and Apparatus for the Insertion of Foils into Catalytic Reactors

(75) Inventors: Anthony Henry Reading, Abingdon (GB); Iain Kenneth Baxter, Abington (GB); Ross Alexander Morgan, Abingdon (GB)

(73) Assignee: CompactGTL plc, Abingdon Oxfordshire (GB)

(21) Appl. No.: 13/125,416

(22) PCT Filed: Oct. 21, 2009
(86) PCT No.: PCT/GB09/51415

§ 371 Date: Apr. 21, 2011

(30) Foreign Application Priority Data
Oct. 24, 2008 (GB) 0819520.8
Dec. 11, 2008 (GB) 0822531.0

(51) Int. Cl. B01J 4/00; B01J 8/08

(52) U.S. Cl. 414/800; 422/219; 422/107

(57) ABSTRACT

An insertion apparatus is provided for inserting at least one catalytic insert into each of a multiplicity of reactor channels. The apparatus includes a magazine configured to locate a multiplicity of catalytic inserts, a guide element for guiding the movement of a catalytic insert as it is inserted into the reaction channel, and a pushing member to push a catalytic insert out of the magazine, through the guide element, and into a reactor channel. An automated method for inserting catalytic inserts into reactor channels is also provided. The method includes the steps of: aligning the insert with a reaction channel, and pushing the insert through a guide element into the channel.

### CROSS-REFERENCE TO RELATED APPLICATION

This application is a continuation of PCT Application No. PCT/GB2009/051415, filed Oct. 21, 2009 and claiming priority to GB Application Nos. 0819520.0 filed Oct. 24, 2008 and 0822531.0 filed Dec. 11, 2008, the disclosure of which is incorporated herein by reference in its entirety.

This invention relates to improved catalyst foil configurations and to a procedure, to an apparatus and to a method, for inserting catalyst foils into catalytic reactors.

Catalytic reactors provide an environment in which the speed and efficiency of a chemical reaction can be improved using a catalyst. Many different types of reactions can be catalyzed, for example combustion, steam methane reforming and Fischer-Tropsch synthesis; these may all be used in a Gas-to-Liquid (“GTL”) conversion process. Different types of catalytic reactor are known for GTL conversion process, for example such as slurry bed reactors, fixed bed reactors and compact reactors. Compact reactors comprise a multiplicity of channels extending through a reactor block. In a compact reactor the catalyst is provided on a surface and the reagents are brought into contact with that surface. It has been suggested to coat the walls of the channels with the catalyst. However, in order to maximize the volume of the reagents that is brought into contact with the catalyst, the channels have to be very small. It has therefore been suggested that the catalyst can be mounted onto one or more foils that are introduced into each of the reactor channels.

The provision of the catalyst on foils has a number of advantages including a considerable increase in the surface area for catalyst within a small volume, and the foils can have sufficiently high voidage that the flow of reactants through the channel is not unduly impeded. In addition, the lifetime of the reactor as a whole can be limited by the life of the catalyst, whereas, if the catalyst is provided on foils, the foils can be replaced thereby increasing the life of the reactor as a whole.

A large reactor may define several thousand reactor channels, so that insertion of the catalytic inserts can be time-consuming. The insertion must also be carried out carefully to avoid damaging the insert and to avoid the risk of obstructing the flow channel. This can be problematic because the cross-sectional area of the foil or foils to be inserted into a channel is typically similar to the cross-sectional area of the channel itself and therefore the insertion process must be carried out accurately. Furthermore, ceramic coated foils are highly abrasive and are difficult to handle. In addition, when a channel is to contain a number of separate foils that form a stack of foils, further problems arise.

The present invention is applicable to any reactor block in which there are a multiplicity of reaction channels into which catalyst inserts are to be inserted. The reactor block itself may comprise a stack of plates. For example, first and second flow channels may be defined by grooves in respective plates, the plates being stacked and then bonded together. Alternatively the flow channels may be defined by thin metal sheets that are castellated and stacked alternately with flat sheets; the edges of the flow channels may be defined by sealing strips. The nature of the first and second flow channels would depend upon the reaction or reactions that are to occur in the reactor block. For example channels for an exothermic chemical reaction may be arranged alternately in the stack with channels for an endothermic reaction; in this case appropriate catalysts would have to be inserted into each channel. For example the exothermic reaction may be a combustion reaction, and the endothermic reaction may be steam methane reforming. In other cases channels for a chemical reaction (first channels) may be arranged alternately in the stack with channels for a heat transfer medium, such as a coolant. In this case catalytic inserts would only be required in the first channels. For example the first channels may be for performing the Fischer-Tropsch reaction, and the heat transfer medium would in this case be a coolant.

The present invention has been devised in order to address and mitigate some or all of the above mentioned problems.

According to the present invention there is provided an insertion apparatus for inserting at least one catalytic insert into each of a plurality of reactor channels, the apparatus comprising: a magazine configured to hold at least one catalytic insert, a guide element for guiding the movement of the catalytic insert as it is inserted into the reaction channel, and a pushing member to push a catalytic insert out of the magazine, through the guide element, and into a reactor channel.

The apparatus may further comprise means to align the guide element with a reactor channel. In addition, the apparatus may further comprise means for monitoring the alignment of the guide element with the reactor channel. The means for monitoring may be a camera, a video camera. Alternatively, the monitoring means may use laser or ultrasound technology to monitor the alignment of the guide element.

The guide element may provide an aperture through which the catalytic insert is configured to pass, in use. The aperture may be tapered along its length, and/or comprises rollers, so that the catalytic insert is slightly compressed during passage through the guide element.

The magazine may define a multiplicity of grooves, wherein each groove is sized and configured to locate a catalytic insert. Alternatively, the magazine may define a single elongate groove in which a plurality of inserts may lie in an end to end configuration. The magazine with a plurality of grooves each sized for a single insert may be preferred as this minimizes the distance that each insert has to be pushed in order to insert it into the reactor. As the inserts are highly abrasive it is preferable both for the integrity of the catalyst on the insert, but also for the magazine, to minimize the distance that each insert has to be pushed.

As another alternative, if the catalytic insert is in the form of a single item prior to insertion, the magazine may contain a stack of catalytic inserts on top of each other, and on each operation of the insertion apparatus one of the catalytic inserts is pushed out of the magazine.

The apparatus may further comprise at least one roller configured to bear against at least one face of the catalytic insert while it is pushed out of the magazine. The roller, or rollers, may be located above the magazine so as to roll along the upper face of the insert as it is pushed out of the magazine. The downward force provided by the roller or rollers will in some cases help to prevent the catalytic insert from buckling during the insertion process.

The pushing member may comprise a pushing rod with an end face which may be configured to abut the catalytic insert, in use. The end face may be made of resilient plastic.

Furthermore, according to the present invention there is provided a control system for controlling the insertion apparatus according to any one of the preceding claims, the control system comprising: a microprocessor configured to receive data from one or more sensors, an actuator configured to control the pushing member and an actuator configured to move at least part of the apparatus to provide alignment between the guide element and a reactor channel.

One of the sensors may be a pressure sensor located on the pushing member. One of the sensors may be an optical sensor configured to confirm alignment of the insert with the channel. The actuator may further be configured to move at least part of the apparatus to provide alignment between the catalytic insert and the guide element. One of the sensors may be configured to confirm that a channel is correctly sized and not blocked. If a channel is identified that is blocked, then the control system will not attempt to insert an insert into such a channel. This will reduce the number of instances of failure of the apparatus resulting from an insert being part-inserted into a channel which is blocked or mis-sized. In addition, the control system may further comprise means for storing reactor layout information which is configured to record data from the sensor identifying blocked channels. The means for storing reactor layout information may be a memory that can be updated with further relevant data about the status of the channels in the reactor.

Moreover according to the present invention there is provided an automated method for inserting catalytic inserts into reactor channels, the method comprising the steps of: aligning the insert with a reaction channel, and pushing the insert through a guide element into the channel. The alignment may be monitored using a camera providing feedback to the alignment means.

The catalytic insert may comprise a plurality of insert elements stacked together. The method may further comprise the step of bonding the insert elements together before aligning the insert with the reaction channel, the insert may be bonded together using a shrinkwrap sheet. The method may further comprise cutting and peeling away the shrinkwrap sheet as the insert is pushed into the channel.

The method may further comprise the step of checking that the reaction channel is correctly sized and not blocked prior to the step of pushing the insert through the guide element into the channel. This step may be carried out directly before the step of pushing the insert through the guide element into the channel. Alternatively, this step may take place before the step of aligning the insert with a reaction channel. It is especially important to check that the channel is not too small for the insert as attempting to insert an insert into an undersized channel could result in a blockage that may stop the insertion apparatus.

The method may further comprise the step of pushing a second insert through the guide element into the same channel.

The method may further comprise the step of moving the guide element and pushing rod into alignment with a second reactor channel and repeating the steps described above. The method may further comprise the step of moving the magazine into alignment with a second reactor.

The insertion apparatus may comprise a plurality of pushing members and a plurality of guide elements, so that a plurality of catalytic inserts can be inserted simultaneously from the magazine. This is only feasible if the reactor channels are at well-defined separations, and it is generally preferable to insert only one catalytic insert at a time, as this simplifies the step of aligning the insert with the channel.

Where the catalytic insert comprises a plurality of insert elements stacked together, for example a stack of corrugated foils and flat foils, these may be bonded together before insertion. For example they may be spot welded together. Alternatively they may be bonded together in a temporary fashion, for example being secured together by a wrapping strip, such as a shrink-wrap sheet, or being secured together by a plastic clip or end cap; or being secured together by being embedded in a low-melting point material such as wax. It is usually desirable to remove the wrapping strip or the clip as the insert is inserted into the channel, and this may be carried out using a cutter associated with the guide element to peel the wrapping strip away or to cut off the clip. Hence the method may further comprise cutting and peeling away of the wrapping strip or the clip as the insert is pushed into the channel. On the other hand, if the insert elements are embedded in wax, which has the benefit of helping to lubricate the passage of the catalytic insert along the channel, the wax may be subsequently removed by heating the reactor block so that the wax melts.

Alternatively the insert elements that form the catalytic insert may be located in a groove or channel within a magazine, without being bonded together. If the catalytic insert is located in a groove, it may be held down when being pushed into the reactor channel to ensure it does not bow as it is pushed along; this may use rollers adjacent to the groove.

The pushing member preferably has a resilient plastic end face that abuts the catalytic insert rather than a hard metal end face, to avoid damaging the end of the insert, for example a polypropylene end face. Preferably the pushing member incorporates a force sensor, and operation of the pushing member is stopped if the measured force exceeds a threshold.

The invention will now be further and more particularly described, by way of example only, and with reference to the accompanying drawings in which:

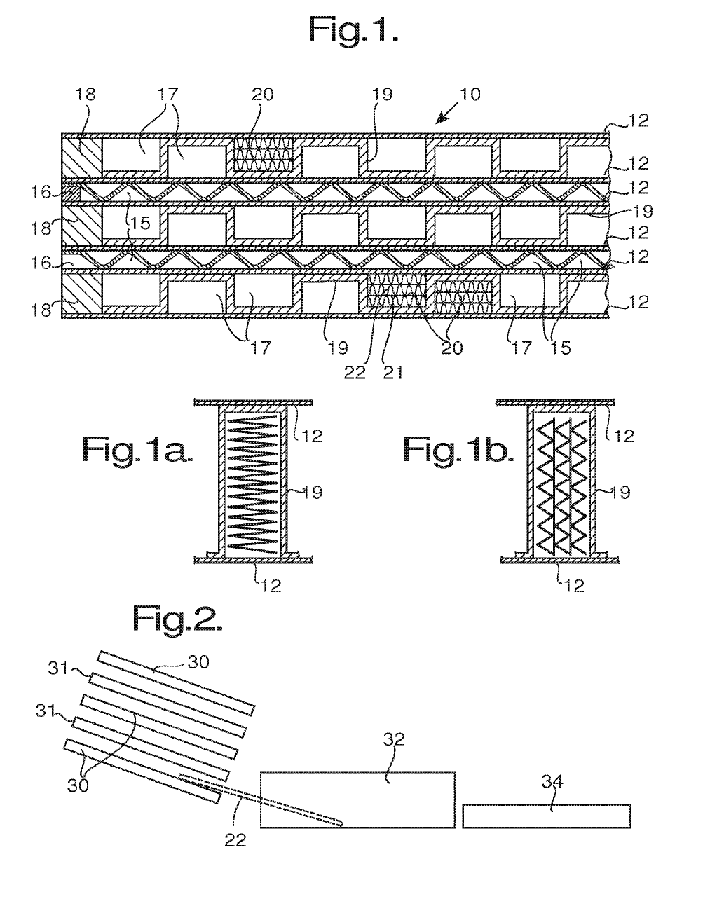

FIG. 1 shows a cross-sectional view of part of a reactor block;

FIGS. 1a and 1b show views of alternative reaction channel arrangements;

FIG. 2 shows a side view of an apparatus for forming stacks of foils;

FIG. 3 shows a cross-sectional view of an apparatus for inserting stacks of foils; and

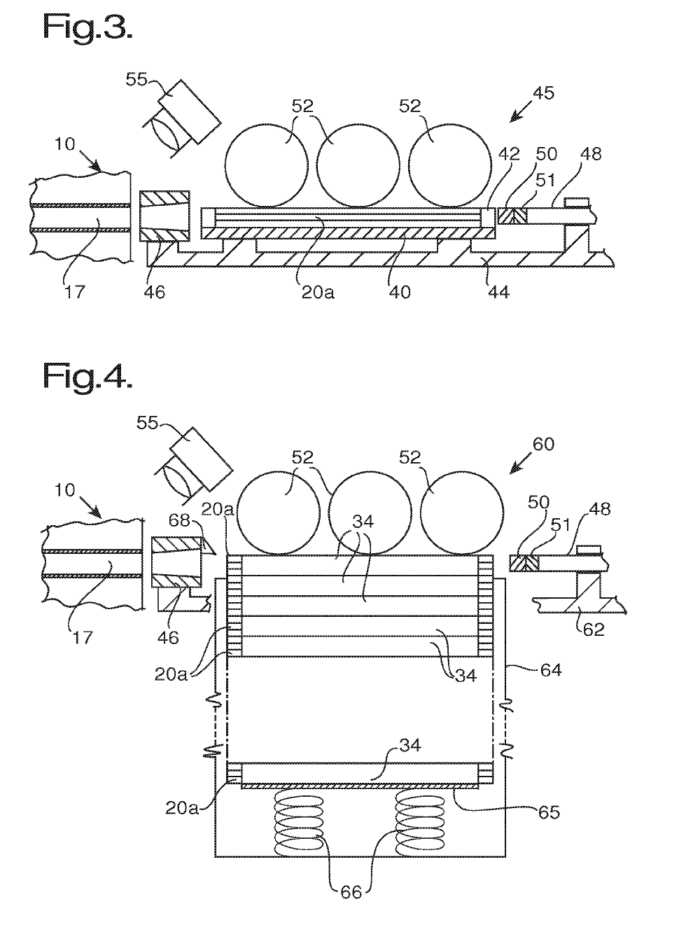

FIG. 4 shows a cross-sectional view of an alternative apparatus for inserting stacks of foils.

Referring to FIG. 1 there is shown a reactor block 10 suitable for performing Fischer-Tropsch synthesis, the reactor block 10 being shown in section and only in part. The reactor block 10 consists of a stack of flat plates 12 of thickness 1 mm spaced apart so as to define channels 15 for a coolant fluid alternating with channels 17 for the Fischer-Tropsch synthesis. The coolant channels 15 are defined in addition by sheets 14 of thickness 0.75 mm shaped into flat-topped sawtooth corrugations, with solid edge strips 16. The channels 17 for the Fischer-Tropsch synthesis are sealed by solid edge bars 18 and are defined in addition by sheets 19 of thickness 1.0 mm shaped into castellations of height typically in the range of 4 mm to 12 mm, for example 5 mm. In one example the resulting channels 17 are of width 10 mm and of height 5 mm and extend straight through the stack from one face to the opposite face. Within each of the channels 17 for Fischer-Tropsch synthesis is provided a catalytic insert 20. By way of example this insert 20 may comprise a stack of flat foils 21 and corrugated foils 22 each of thickness typically in the range from 20-150 μm, for example 50 μm, with a ceramic coating acting as a support for the catalytic material (only three such inserts 20 are shown). In the figure each insert 20 consists of two generally flat foils 21 (which may in practice define corrugations with an amplitude of say 0.1 mm for greater rigidity), separating three longitudinally corrugated foils 22. An alternative insert 20 might consist of a single corrugated foil whose corrugations are substantially the height of the channel 17, or alternatively two corrugated foils separated by a flat foil.

The foils may be fabricated from a steel alloy that forms an adherent surface coating of aluminum oxide when heated, for example an aluminum-bearing ferritic steel such as iron with 15% chromium, 4% aluminum, and 0.3% yttrium (eg Fecralloy™). When this alloy is heated in air it forms an adherent oxide coating of alumina, which protects the alloy against further oxidation and against corrosion. Where the ceramic coating is of alumina, this appears to bond to the oxide coating on the surface.

In an alternative example, not illustrated, the foils that provide the substrate for the catalyst may be replaced with a wire mesh or a felt sheet, which may be corrugated, dimpled or pleated. It will be appreciated that one or more catalyst inserts 20 are provided throughout the length of the reaction channel 17 where catalytic reaction is to occur. The reactor channel 17 may for example be of length 150 mm or more, for example up to 1 m, such as 600 mm; and consequently the insert 20 will be of comparable length—for example two inserts 20 each of length 300 mm might be inserted end to end in a channel of length 600 mm.

In FIG. 1 the reaction channels 17 are wider (in the direction parallel to the flat plates 12) than they are high, but the reaction channels 17 might instead be of square cross-section, or alternatively they might be higher than they are wide. The catalytic inserts 20 described above consist of one or more corrugated foils whose center plane is parallel to the flat plates 12, but alternatively the corrugated foil or foils may be arranged with their center plane orthogonal to the flat plates 12. If the reaction channels 17 are narrower (in the direction parallel to the flat plates 12) than they are high, then as shown in FIGS. 1a and 1b it may be more convenient to arrange the corrugated foil or foils with their center planes orthogonal to the flat plates 12. Hence the catalytic inserts may either be a single corrugated foil whose corrugations are substantially the width of the channel, as shown in FIG. 1a, or alternatively a stack of foils as shown in FIG. 1b.

It is to be emphasized that FIG. 1 shows only a part of the reactor block 10. The number of channels 17 into which inserts 20 must be inserted depends on the size of the reactor block 10, but for example if the end face of the reactor block 10 is 0.36 m by 0.36 m there may be more than one thousand such channels 17. With the structure described above, each foil 21 and 22 is of width just less than 5 mm, of foil thickness 50 microns, and of length typically that of the channel or half that of the channel, say of length 300 mm, and is therefore not a rigid object. Inserting such a large number of catalyst inserts 20 made up of non-rigid foils 21 and 22 is not a simple matter.

In this example it will be assumed that the corrugated foils 22 are supplied in trays or racks 30 and the flat foils 21 are supplied in trays or racks 31, for example with grooves with one foil 21 or 22 in each. Since more than one foil is to be provided within each channel 17, the first stage of the insertion process is to produce a foil stack for use as an insert 20. This may be done using a robot arm arranged to pick up appropriate foils 21 or 22 successively, and to place them as a foil stack.

Alternatively, referring now to FIG. 2, the trays 30, 31 may be arranged one above each other and inclined, the bottommost tray 30 containing corrugated foils 22 and the other trays alternately containing flat foils 21 and corrugated foils 22. These are adjacent to a stack-forming block 32 that defines a multiplicity of deep grooves that taper towards the bottom of the block 32 to a width just greater than that of a foil 21 or 22, the deep grooves being aligned with the grooves in all the trays 30 and 31. The foils 22 from the bottom tray 30 are all pushed out into the corresponding grooves in the block 32; the foils 21 from the next tray 31 are then pushed out so they end up on top of the corrugated foils 22 at the bottom of the deep grooves; and then the corrugated foils 22 from the next tray 30 are then pushed out; and similarly for all five trays 30 and 31 in succession, so foil stacks are formed at the bottom of all the deep grooves in the block 32. The trays 30 and 31 are inclined to ensure that as each foil 21 or 22 is pushed out, at one instant its front end is resting in the bottom of the deep groove while its other end is still in the tray; this reduces the risk of foils not lying flat in the deep grooves.

The foils from the trays 30, 31 may be pushed out in quick succession or at substantially the same time, in order to form stacks in the stack-forming block 32. Alternatively this may be done with just one foil from each tray 30, 31, so as to form a single stack.

As one option, the foil stacks are then pushed out of the deep grooves in the stack forming block 32 into aligned shallow grooves in a magazine plate 40 (shown in FIG. 3). Each magazine plate 40 defines a multiplicity of parallel shallow grooves 42, in each of which a foil stack 20a is thereby introduced. Such magazine plates 40 may then be stacked on top of each other, for example in a box with a loose push-up base, for subsequent use. Alternatively each magazine plate 40 may be covered by a clip-on cover to ensure that the foils stacks 20a do not fall out; such a clip-on cover may include projections that extend into the end portions of the grooves 42. Indeed successive magazine plates 40 may clip on top of each other to secure the foil stacks 20a in the lower magazine plates 40, and again the underside of the magazine plates 40 in this case may include projections such as teeth that extend into the end portions of the grooves 42. As yet another alternative each magazine plate 40 may itself be enclosed within a shrink-wrap film to ensure there is no risk of the foil stacks 20a falling out.

Alternatively, each of the foil stacks is then pushed out of the stack-forming block 32 into a respective shrink-wrap tube 34, and these tubes 34 are heated to hold the foils 21 and 22 in each stack together. The shrink-wrap tubes 34 are of a material of sufficient thickness to hold the foils 21 and 22 securely together, and also to be peelable subsequently without tearing. The shrink-wrap tubes 34 are also configured to compress the stacks in the vertical direction. However, it is important that the tubes 34 do not place excessive pressure on the stack as this could result in the stack becoming mis-shapen. The resulting shrink-wrapped stacks can be subsequently loaded into a spring-loaded magazine 64 (as shown in FIG. 4), one on top of another, for subsequent insertion (as described below).

Once the catalytic inserts are packed, either into a magazine, magazine plate or shrink wrapped, the inserts are protected and may for example be transported to a reactor manufacturer where inserts are provided in new reactors, or to a reactor reconditioning plant where inserts are provided to replace inserts on which the catalyst is spent. The magazine, magazine plate or shrink-wrap tubes effectively form the transit packaging for the inserts. This packaging may be disposable or returnable. When the inserts arrive at the reactor manufacturer or the reconditioning plant they are then inserted using apparatus as shown in FIG. 3 or FIG. 4. Alternatively the production of foil stacks may take place at the same plant where they are to be inserted.

Referring now to FIG. 3 an insertion apparatus 45, which may be robotic comprises a support structure 44 (represented diagrammatically) for supporting a magazine plate 40, an insertion guide 46 on one side of the magazine plate 40, and a pushing member or insertion plunger 48 aligned with the insertion guide 46 but on the opposite side of the magazine plate 40. The insertion plunger 48 has a polypropylene end face 50 behind which is a pressure sensor 51. The face 50 of the insertion plunger 48 must have sufficient vertical extent that it always interfaces with all of the foils in the stack. However, it must also fit into the channel especially in the instance where two 300 mm long stacks are inserted into one 600 mm long channel. In this case, the plunger 48 must be sufficiently long that the face 50 can travel 300 mm down the channel.

Three resiliently mounted rollers 52 rest on the foil stack 20a in the groove 42 that is aligned with the insertion guide 46. Although three rollers 52 are shown the number of rollers provided is partly dictated by the length of the catalytic insert: if the insert is longer then more rollers may be used. Furthermore, the number of rollers provided is partly a compromise between the extent of the contact provided between the rollers and the catalytic insert and the radius of the rollers. Because the ceramic that coats the catalytic foils is very abrasive, fine abrasive dust may be present in the immediate vicinity of the inserts and therefore if a large number of small radius rollers is used the dust may damage the bearings of the rollers and reduce their useful lifetime. Conversely, if one large roller is used the extent of the contact between the roller and the catalyst insert is limited. For a catalytic insert of 300 mm length between two and five rollers may be used.

The support structure 44 has two degrees of freedom: up or down, and into and out of the plane of the paper as shown in FIG. 3. In operation the apparatus 45 is set up next to a reactor block 10, the reactor block 10 preferably being arranged so that the channels 17 are horizontal. The movements of the support structure 44 are controlled by a controller (not shown) to align the insertion guide 46 with a reaction channel 17. To allow for the uncertainty in the exact position of each reaction channel 17 that arises owing to manufacturing tolerances, at least the location of the end of the reaction channel 17 is checked by a video camera 55, providing signals to the controller. In addition, the video camera 55 may be used to confirm that the channel 17 is not blocked and is of a sufficient size to receive the foil stack 20a. When the insertion guide 46 is aligned with a suitably sized channel 17 that is free of obstruction, the insertion plunger 48 is activated to push the foil stack 20a through the insertion guide 46 and so along the reaction channel 17. The rollers 52 prevent the foils from bowing as they are pushed along. The insertion guide 46 in this example defines a tapered aperture of rectangular cross-section, whose narrowest end is slightly smaller than the dimensions of the reaction channel 17. In this example the insertion guide 46 is of a low friction plastic material such as polytetrafluoroethylene. In an alternative example, the insertion guide 46 may be of a hard material, such as stainless steel.

As soon as this insertion has been completed, the insertion plunger 48 is withdrawn. The rollers 52 are slightly raised up, and the magazine plate 40 is moved along so that the next groove 42 is aligned with the insertion guide 46, and the rollers 52 are lowered back into the position as shown. The support structure 44 can then be moved to align with another channel 17. When all the foil stacks 20a in the magazine plate 40 have been inserted in this fashion, the magazine plate 40 is replaced by a new magazine plate 40.

In an alternative not shown in the accompanying figures, the insertion guide may comprise one or more pairs of opposed rollers between which the foil stack 20a is pushed. These rollers may be passive, or they may be driven. The foil stack is of resilient material, and in every case the effect of the insertion guide 46 is to squeeze the foil stack 20a sufficiently to ensure that it does not catch on the edges of the channel 17 as it is inserted. The pressure sensor 51 provides further assurance of satisfactory operation, because it enables the computer controller to cease insertion if a blockage occurs.

Referring now to FIG. 4 there is shown an alternative insertion apparatus 60, having some features in common with the insertion apparatus 45 of FIG. 3, similar features being referred to by the same reference numeral. The insertion apparatus 60 comprises a support structure 62 (represented diagrammatically) for supporting a magazine 64, an insertion guide 46 on one side of the magazine 64, and an insertion plunger 48 aligned with the insertion guide 46 but on the opposite side of the magazine 64. In this example the magazine 64 uses foil stacks 20a held together by the shrink-wrapped tubes 34 as mentioned above in relation to FIG. 2. A large number of these are stacked on top of each other (only six are shown in the figure) in the magazine 64 resting on a base plate 65 supported on springs 66. The magazine 64 is supported such that the topmost foil stack 20a is above the top of the magazine 64, and rests against three rollers 52. Projecting from the face of the insertion guide 46 closest to the magazine 64 is a cutting blade 68 arranged to cut through the shrink-wrap tubes 34, the tip of the blade 66 fitting between corrugations of the topmost corrugated foil 22 in the foil stack 20a and the blade being shaped to peel away the material of the tube 34. This avoids the risk of the material of the tube 34 from entering the reaction channel 17.

The use of the insertion apparatus 60 is partly analogous to that of the insertion apparatus 45, in that the support structure 62 is moved to align the insertion guide 46 with a reaction channel 17, the accuracy of this alignment and the suitability of the channel to accept the insertion of the foil stack 20a being checked by a video camera 55. When the insertion guide 46 is aligned, the insertion plunger 48 is activated to push the foil stack 20a through the insertion guide 46 and so along the reaction channel 17. As the foil stack 20a passes through the insertion guide 46 the blade 68 ensures that the shrink-wrapped tube 34 is peeled off. When the insertion plunger 48 is withdrawn, the springs 66 ensure that the next foil stack 20a rises up to abut the rollers 52, so the insertion apparatus 60 is ready for the next insertion.

The video camera 55 and the sensor 51 on the insertion plunger 48 feed data into the controller. The controller is configured to receive data from the video camera 55 and the sensor 51 and to send commands to one or more actuators (not shown) which are configured to move the magazine 64 or the magazine plate 40 and/or the support structure 44, 62 relative to the reactor block 10. Data from the video camera 55 will confirm when the insertion guide 46 is aligned with a channel 17 and confirm that the channel is correctly sized and not blocked. It may also be used to check that the catalytic insert in the magazine or magazine plate is aligned with the insertion guide 46.

When the insertion apparatus 60 shown in FIG. 4 is used, the magazine 64 must be moved to address each channel 17. This may correspond to movement following each insertion if only one foil or foil stack 20a is to be inserted into each channel. However, when the insertion apparatus 45 shown in FIG. 3 is used, if the grooves 42 in the magazine plate 40 are configured to have the same separation as the channels 17 in the reactor block, then the insertion guide 46 and insertion rod 48 may instead be moved relative to the magazine plate 40 and the support structure 44.

The controller also controls the movement of the insertion plunger 48. The insertion plunger 48 is actuated to push a single foil or foil stack into a channel 17. If the foil(s) experience any undue resistance, for example as a result of a blockage in the channel 17, the sensor 51 will feed back data to the control system which will alter the force used on the insertion plunger 48. If the force used by the insertion plunger 48 is excessive it can result in the foil(s) being damaged, for example by buckling. The controller can be configured to alter the force, and therefore the speed at which the foil or foil stack is pushed into the channel. For example, the controller may initiate the movement of the insertion plunger 48 with a low force resulting in the initial movement of the foil or foil stack being comparatively slow. Once the foil or foil stack is at least partly contained within the channel, the channel effectively provides support for the foil and the force on the insertion plunger 48 can be increased and therefore the speed of insertion can also be increased.

The controller is further provided with information relating to the layout of the reactor, including the number of channels into which a foil or foils need to be inserted. This reactor layout information may be stored in a memory or other suitable storage means. Location sensors can be provided that are configured to relay information to the controller relating to the channels within the reactor that have been filled. The controller uses this data to identify which channels still have to be filled. The controller sends commands to the actuators to align the insertion guide 46 and insertion rod 48 with channels that need to be filled with a catalyst foil or foils. In addition, the controller stores data from the video camera 55 indicating that a channel is not correctly sized or is blocked. This data, in combination with the information relating to the layout of the reactor, enables the controller to collate information relating to blocked or mis-sized channels that will require manual attention when the remaining channels in the reactor have been automatically filled. This information can be presented to a skilled operative to help identification of problem channels.

It will be appreciated that the insertion apparatuses 45 and 60 and the processes described above are by way of example only, and that they may be modified in various ways while remaining within the scope of the present invention. For example in the apparatus 60 the rollers 52 may be omitted, and the magazine 64 may have a top plate against which the topmost foil stack 20a rests; in this case there are windows on opposite sides of the top of the magazine 64 for the foil stack 20a and the plunger 48 to pass through. In each case the foil stack 20a is described as being pushed in by a plunger 48, but in alternative arrangements at least part of the driving force for insertion of the foil stack 20a may be provided by actively driven rollers or continuous belts on either side of the foil stack.

Furthermore, although the examples described with reference to FIGS. 3 and 4 may optionally use a video camera to monitor the alignment of at least the insertion guide 46 with the channel 17, and possibly also to monitor the channels to identify blockages and/or mis-sized channels and, in addition, the alignment of the magazine 64 or magazine plate 40 and insertion rod 48 with the insertion guide 46, it will be understood that any suitable optical sensing means can be used to confirm the alignment including a stills camera or light sensor. In particular, sensing means using laser or ultrasound technology may be used to check alignments and/or to identify blocked or mis-sized channels. All of the activities set out above may be carried out by a single video camera 55, a number of separate video cameras 55 or other suitable means already described. Alternatively, a variety of sensors of different types may be provided.

The apparatus can be used to introduce catalytic inserts into a new reactor or to replace catalytic inserts during reactor reconditioning. The lifespan of a reactor may be in the region of 10 years, whereas the catalyst life may be only in the region of three years. It will therefore be necessary to recondition a reactor, by providing a new set of catalytic inserts 20 three or four times within the life of a reactor.

The support structure and the size of the magazine or magazine plate may be altered according to the situation in which the apparatus is intended to be deployed. For example, if the apparatus is to be deployed on the site where the reactors are manufactured, then the support apparatus may be substantial and may comprise a plurality of insertion rods and insertion guides that are capable of providing multiple simultaneous insertions of catalytic inserts into different reactor channels on the same reactor. Conversely, if the apparatus is to be deployed as part of a reactor reconditioning, this may require the apparatus to be at least partially portable and therefore a smaller support structure and correspondingly fewer insertion rods and insertion guides will be provided.

If the reactor is a steam methane reforming reactor, the reactor channels for combustion and those for steam methane reforming may be accessible from opposite sides of the reactor. Therefore, two sets of apparatus as described above may be used together, one at either side of the reactor, one inserting combustion catalytic inserts into the combustion channels and the other inserting steam methane reforming catalytic inserts into the steam methane reforming channels.

Conversely, if the reactor is a Fischer-Tropsch reactor, there may be access to both ends of the reaction channels 17, and in this case the catalyst inserts can be inserted from either side of the reactor block. In this case, two sets of apparatus may be used simultaneously inserting catalytic inserts into the same reactor channels. This is especially advantageous in the situation where the reactor channel length is double the length of the catalyst insert. In this case, each apparatus can insert one catalytic insert into each channel.

1. An insertion apparatus for inserting at least one catalytic insert into each of a multiplicity of reactor channels, the apparatus comprising:
a magazine configured to locate a multiplicity of catalytic inserts,
a guide element for guiding the movement of a catalytic insert as it is inserted into the reaction channel, and
a pushing member to push a catalytic insert out of the magazine, through the guide element, and into a reactor channel.

2. An insertion apparatus as claimed in claim 1, further comprising means to align the guide element with a reactor channel.

3. An insertion apparatus as claimed in claim 2, further comprising means for monitoring the alignment of the guide element with the reactor channel.

4. An insertion apparatus as claimed in claim 1, wherein the guide element provides an aperture through which the catalytic insert is configured to pass, in use.

5. An insertion apparatus as claimed in claim 4, wherein the aperture is tapered along its length, and/or comprises rollers.

6. An insertion apparatus as claimed in claim 1 wherein the magazine defines a multiplicity of grooves, wherein each groove is sized and configured to locate a catalytic insert.

7. An insertion apparatus as claimed in claim 1 further comprising at least one roller configured to bear against at least one face of the catalytic insert while it is pushed out of the magazine.

8. An insertion apparatus as claimed in claim 1 wherein the pushing member comprises a pushing rod with an end face.

9. A control system for controlling the insertion apparatus according to claim 1, the control system comprising:
a controller configured to receive data from one or more sensors,
an actuator configured to control the pushing member and
an actuator configured to move at least part of the apparatus to provide alignment between the guide element and a reactor channel.

10. A control system as claimed in claim 9, wherein one of the sensors is a pressure sensor located on the pushing member.

11. A control system as claimed in claim 9, wherein one of the sensors is an optical sensor configured to confirm alignment of the insert with the channel.

12. A control system as claimed in claim 9, wherein one of the sensors is configured to confirm that a channel is correctly sized and not blocked.

13. A control system as claimed in claim 12, further comprising means for storing reactor layout information which is configured to record data from the sensor identifying blocked channels.

14. An automated method for inserting catalytic inserts into reactor channels, the method comprising the steps of:
aligning the insert with a reaction channel, and
pushing the insert through a guide element into the channel.

15. An insertion method as claimed in claim 14 wherein the alignment is monitored using a camera providing feedback to the alignment means.

16. An insertion method as claimed in claim 14 wherein the catalytic insert comprises a plurality of insert elements stacked together.

17. An insertion method as claimed in claim 14, further comprising the step of checking that the reaction channel is correctly sized and not blocked prior to the step of pushing the insert through the guide element into the channel.

18. An insertion method as claimed in claim 16 further comprising the step of bonding the insert elements together before aligning the insert with the reaction channel.

19. An insertion method as claimed in claim 18 wherein the insert elements are bonded together using a shrink-wrap sheet.

20. An insertion method as claimed in claim 19 wherein the method comprises cutting and peeling away the shrink-wrap sheet as the insert is pushed into the channel.

21. An insertion method as claimed in claim 14, further comprising the step of pushing a second insert through the guide element into the same channel.

22. An insertion method as claimed in claim 14 using an insertion apparatus comprising a magazine configured to locate the catalytic inserts, a guide element for guiding the movement of the insert as it is inserted into the reaction channel, and a pushing member to push the insert out of the magazine, through the guide element, and into a reactor channel, the method further comprising the step of moving the guide element and pushing member into alignment with a second reactor channel and repeating the steps of aligning the insert and pushing the insert through the guide element.

23. An insertion method as claimed in claim 22, further comprising the step of moving the magazine into alignment with a second reactor.
